(19) United States
(12) Patent Application Publication
(10) Pub. No.: US 2026/0368187 A1
(43) Pub. Date: Nov. 19, 2026

(54) LOW POWER SYSTEM AND METHOD FOR AUTOMATED PRE-EXISTING SOLUTION FINDER

(71) Applicant: JPMorgan Chase Bank, N.A., New York, NY (US)

(72) Inventors: Soumitra BANERJEE, Middletown, DE (US); Sakthi MUTHUSWAMY, Bear, DE (US); Muzeeb MOHAMMAD, Greenville, DE (US)

(73) Assignee: JPMorgan Chase Bank, N.A., New York, NY (US)

(21) Appl. No.: 19/631,247

(22) Filed: Mar. 27, 2026

Related U.S. Application Data
(60) Provisional application No. 63/804,945, filed on May 13, 2025.

(51) Int. Cl. G06F 16/2457; G06F 40/279; G06F 40/40

(52) U.S. Cl. CPC G06F 16/24578; G06F 40/279; G06F 40/40

(57) ABSTRACT

An automated methodology for locating pre-published solutions is provided. The method includes: first receiving a natural language input of a technical problem; first identifying, by a natural language processor, specific keywords within the natural language input of the technical problem; reformulating the natural language input of the technical problem, using the specific keywords, into a streamlined input prompt structured to elicit relevant responses to the technical problem; submitting the streamlined input prompt to a model trained to search for relevant pre-published solutions to the technical problem; searching, by the model, for pre-published solutions to the technical problem; ranking, by the model, the pre-published solutions in order of highest relevance; and first returning by the model, the ranked pre-published solutions.

### CROSS REFERENCE TO RELATED APPLICATIONS

This disclosure claims priority to Provisional Patent Application 63/804,945 filed May 13, 2025 entitled LOW POWER SYSTEM AND METHOD FOR AUTOMATED PRE-EXISTING SOLUTION FINDER, the contents of which are incorporated herein by reference in its entirety.

### TECHNICAL FIELD

This disclosure relates to methods and apparatuses for using an artificial intelligence / machine learning (AI/ML) model to provide a low power automated pre-existing solution finder.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Software developers are constantly developing and modernizing software. Software packages such as applications are being built new or modernized in private clouds and public clouds. During development designers encounter multiple issues such as connectivity to on-premises applications, certification management, containerization and the like.

When a technical problem is identified and repaired for a software package, the circumstances are documented in a common document management system, generating a library of pre-published technical solutions for specific technical problems. When a new team or team members encounter the same technical problem in the future, they have to search by brute force for the pre-existing published technical solutions. Search criteria can provide an overwhelming number of responses, and developers need to go through and find a best match for their technical problem. It takes a significant amount of time to identify the technical problem, search for solutions, try a solution, and repeat the process if the solution does not work.

### SUMMARY

The present disclosure, through one or more of its various aspects, embodiments, and/or specific features or sub-components, provides, among other features, various systems, servers, devices, methods, media, programs, and platforms for using an AI/ML model to provide a low power automated pre-existing solution finder.

According to an aspect of the present disclosure, a method is provided. The method includes: first receiving a natural language input of a technical problem; first identifying, by a natural language processor, specific keywords within the natural language input of the technical problem; reformulating the natural language input of the technical problem, using the specific keywords, into a streamlined input prompt structured to elicit relevant responses to the technical problem; submitting the streamlined input prompt to a model trained to search for relevant pre-published solutions to the technical problem; searching, by the model, for pre-published solutions to the technical problem; ranking, by the model, the pre-published solutions in order of highest relevance; and first returning by the model, the ranked pre-published solutions.

The above aspect may have various optional features. The specific keywords may include an underlying infrastructure, underlying services, and an error code for the technical problem. The method may include: prompting, in response to the identifying failing to identify all needed keywords, entry of additional information describing the technical problem; second receiving the additional information; and second returning to the first identifying. The ranking may include second identifying a pre-existing rank order of the pre-published solutions. The method may further include determining whether the pre-existing rank order is current. The method may further include updating, in response to a negative result of the determining, rank order of the pre-existing rank order. The method may further include: selecting a pre-published solution from the ranked pre-published solutions; and repair the technical problem per the selected pre-published technical solution.

According to another aspect of the present disclosure, a system is provided. The system includes a processor and a non-transitory computer readable memory storing instructions programmed to cooperate with the processor to perform operations. The operations include: first receiving a natural language input of a technical problem; first identifying, by a natural language processor, specific keywords within the natural language input of the technical problem; reformulating the natural language input of the technical problem, using the specific keywords, into a streamlined input prompt structured to elicit relevant responses to the technical problem; submitting the streamlined input prompt to a model trained to search for relevant pre-published solutions to the technical problem; searching, by the model, for pre-published solutions to the technical problem; ranking, by the model, the pre-published solutions in order of highest relevance; and first returning by the model, the ranked pre-published solutions.

The above aspect may have various optional features. The specific keywords may include an underlying infrastructure, underlying services, and an error code for the technical problem. The operations may include: prompting, in response to the identifying failing to identify all needed keywords, entry of additional information describing the technical problem; second receiving the additional information; and second returning to the first identifying. The ranking may include second identifying a pre-existing rank order of the pre-published solutions. The operations may further include determining whether the pre-existing rank order is current. The operations may further include updating, in response to a negative result of the determining, rank order of the pre-existing rank order. The operations may further include: selecting a pre-published solution from the ranked pre-published solutions; and repair the technical problem per the selected pre-published technical solution.

According to another aspect of the present disclosure, a non-transitory computer readable memory storing instructions programmed to cooperate with a processor to cause the processor to perform operations. The operations include: first receiving a natural language input of a technical problem; first identifying, by a natural language processor, specific keywords within the natural language input of the technical problem; reformulating the natural language input of the technical problem, using the specific keywords, into a streamlined input prompt structured to elicit relevant responses to the technical problem; submitting the streamlined input prompt to a model trained to search for relevant pre-published solutions to the technical problem; searching, by the model, for pre-published solutions to the technical problem; ranking, by the model, the pre-published solutions in order of highest relevance; and first returning by the model, the ranked pre-published solutions.

The above aspect may have various optional features. The specific keywords may include an underlying infrastructure, underlying services, and an error code for the technical problem. The operations may include: prompting, in response to the identifying failing to identify all needed keywords, entry of additional information describing the technical problem; second receiving the additional information; and second returning to the first identifying. The ranking may include second identifying a pre-existing rank order of the pre-published solutions. The operations may further include determining whether the pre-existing rank order is current. The operations may further include updating, in response to a negative result of the determining, rank order of the pre-existing rank order. The operations may further include: selecting a pre-published solution from the ranked pre-published solutions; and repair the technical problem per the selected pre-published technical solution.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIG. 4 illustrates an exemplary flow chart of a process for using an AI/ML model to provide a low power automated pre-existing solution finder, in accordance with an embodiment.

FIG. 5 illustrates an exemplary flow chart of a process for using an AI/ML model to provide a low power automated pre-existing solution finder, in accordance with an embodiment.

FIG. 6 illustrates a model design that corresponds to a process for using an AI/ML model to provide a low power automated pre-existing solution finder, in accordance with an embodiment.

FIG. 7 illustrates a data flow that corresponds to a process for using an AI/ML model to provide a low power automated pre-existing solution finder, in accordance with an embodiment.

FIGS. 8A and 8B illustrate a data flow that corresponds to a process for using an AI/ML model to provide a low power automated pre-existing solution finder, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

When a technical problem is identified and repaired for a software package, the circumstances are documented in a common document management system, generating a library of pre-published technical solutions for specific technical problems. When a new team or team members encounter the same technical problem in the future, they have to search by brute force for the pre-existing published technical. Search criteria can provide an overwhelming number of responses, and developers need to go through and find a best match for their technical problem. It takes a significant amount of time to identify the technical problem, search for solutions, try a solution, and repeat the process if the solution does not work.

The search cannot simply be handed over to an AI/ML model without significant electrical power consequences. AI processing receives text prompts and provides a corresponding response. Often the user is not satisfied with the response, such as being too generic or not what the user was specifically looking for. The initial problem was the user, who typically is not trained in AI prompt formats, is not entering sufficiently targeted prompts to generate a satisfactory response. The user will then typically generate a modified prompt based on the prior response, and then receive a new response. If this new response is not satisfactory, the process can continue indefinitely.

A technical problem with this approach is that each AI prompt submission consumes a great deal of electrical power, such that continual resubmission of modified prompts in search of a satisfactory response consumes that much more power. Simply stated, receiving a satisfactory answer after ten AI prompt submissions consumes far more power than receiving a satisfactory response after two AI prompt submissions. Electrical power demands for such operations are an industry wide problem, as illustrated by Microsoft recently leasing a nuclear power plant to provide electricity for its data processing operations. Also, raw user input into an AI/ML model requires a complicated AI/ML model that can handle the variety of parameters that the user might input, and such a complicated model consumes a high amount of electrical power per search.

According to an aspect of the present disclosure, a methodology is provided. The methodology includes: first receiving a natural language input of a technical problem; first identifying, by a natural language processor, specific keywords within the natural language input of the technical problem; reformulating the natural language input of the technical problem, using the specific keywords, into a streamlined input prompt structured to elicit relevant responses to the technical problem; submitting the streamlined input prompt to a model trained to search for relevant pre-published solutions to the technical problem; searching, by the model, for pre-published solutions to the technical problem; ranking, by the model, the pre-published solutions in order of highest relevance; and first returning by the model, the ranked pre-published solutions.

The above aspect may have various optional features. The specific keywords may include an underlying infrastructure, underlying services, and an error code for the technical problem. The methodology may include: prompting, in response to the identifying failing to identify all needed keywords, entry of additional information describing the technical problem; second receiving the additional information; and second returning to the first identifying. The ranking may include second identifying a pre-existing rank order of the pre-published solutions. The methodology may further include determining whether the pre-existing rank order is current. The methodology may further include updating, in response to a negative result of the determining, rank order of the pre-existing rank order. The methodology may further include: selecting a pre-published solution from the ranked pre-published solutions; and repair the technical problem per the selected pre-published technical solution.

The above methodologies provide a technical improvement via a technical solution to the technical problems of traditional methods. The designers will not need to engage in endless brute force searches for solutions. Also, by reformulating the natural language input, using the specific keywords, into a streamlined input prompt structured to elicit relevant responses, the AI prompt is targeted and far more likely to elicit relevant responses from the AI such that resubmissions are less likely. The above methodology thus provides a technical solution to excessive power consumption by reducing the number of AI prompts the user will need to submit to reach an acceptable rank order of pre-existing published solutions. By avoiding extra AI cycles, the methodology avoids the corresponding power expenditure, such that the methodology overall consumes less power. By transforming free-form user input into a structured prompt representation, the system reduces ambiguity and decreases variance in AI-generated outputs.

As a result, the number of iterative prompt submissions required to obtain an acceptable ranked list of pre-existing published solutions is reduced. Empirical testing demonstrates that the structured prompt representation decreases average resubmission frequency and total token utilization per completed search session. From a computing-resource perspective, each AI prompt submission triggers execution of a high-complexity inference operation across distributed computer infrastructure, consuming processor cycles, memory bandwidth, and electrical power proportional to token count and model depth. By reducing the number of prompt submissions and optimizing token utilization per submission, the disclosed system decreases aggregate inference executions. This directly reduces processor load, GPU utilization time, memory access operations, and network transmission overhead associated with each session.

Accordingly, the disclosed methodology provides a technical improvement to computer-implemented AI query systems by: reducing total inference operations executed by remote AI compute clusters; reducing token processing volume per user task; reducing GPU/CPU processing cycles and associated electrical power consumption; reducing network bandwidth utilization between client and AI service endpoints; and improving response determinism and ranking convergence rate within AI-assisted prior-art search workflows.

Also, by reformulating the natural language input, using the specific keywords, into a streamlined input prompt structured to elicit relevant responses, a simpler AI/ML model can be used as it has less parameters to consider, which independently results in savings in electrical power. The instant AI model may be simpler than a general purpose AI model in that it may be specifically designed as a special purpose model programmed and trained to operate off the specific keywords as specific input parameters rather than a general purpose AI model that works off any parameters, and thus consumes less electrical power than a general purpose AI model. Thus a technical improvement in power savings is realized via both a less power hungry AI/ML model and a lower number of submissions, thus reducing the per search power consumption and the number of searches that draw power.

Because the input is normalized into a predefined parameter space, the downstream model is not required to support open-domain inference across arbitrarily structured inputs. Instead, the model operates on a bounded feature vector derived from extracted keywords, domain classifications, and structured ranking constraints. The simplified and special purpose model architecture by its nature includes fewer transformer layers, reduced attention head counts, smaller embedding dimensionality, or a compressed parameter set relative to a general-purpose large language model. Because the model receives semantically filtered and structured inputs rather than free-form text, the inference search space is reduced, permitting lower computational depth while maintaining task-specific accuracy.

Unlike a general-purpose AI model configured to process arbitrary natural language across broad domains, the disclosed special-purpose model is trained and programmed to operate on defined keyword fields and structured prompt parameters as explicit input variables. This constrained input design reduces token entropy, minimizes internal attention operations, and decreases the number of multiply-accumulate operations executed during inference. As a result, GPU/CPU utilization time, memory bandwidth usage, and cache access frequency are reduced relative to execution of a larger, general-purpose model.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term "comprising" when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ± 5% may be expected.

“First,” “second,” etc., re labels to distinguish components or blocks of otherwise similar names, but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

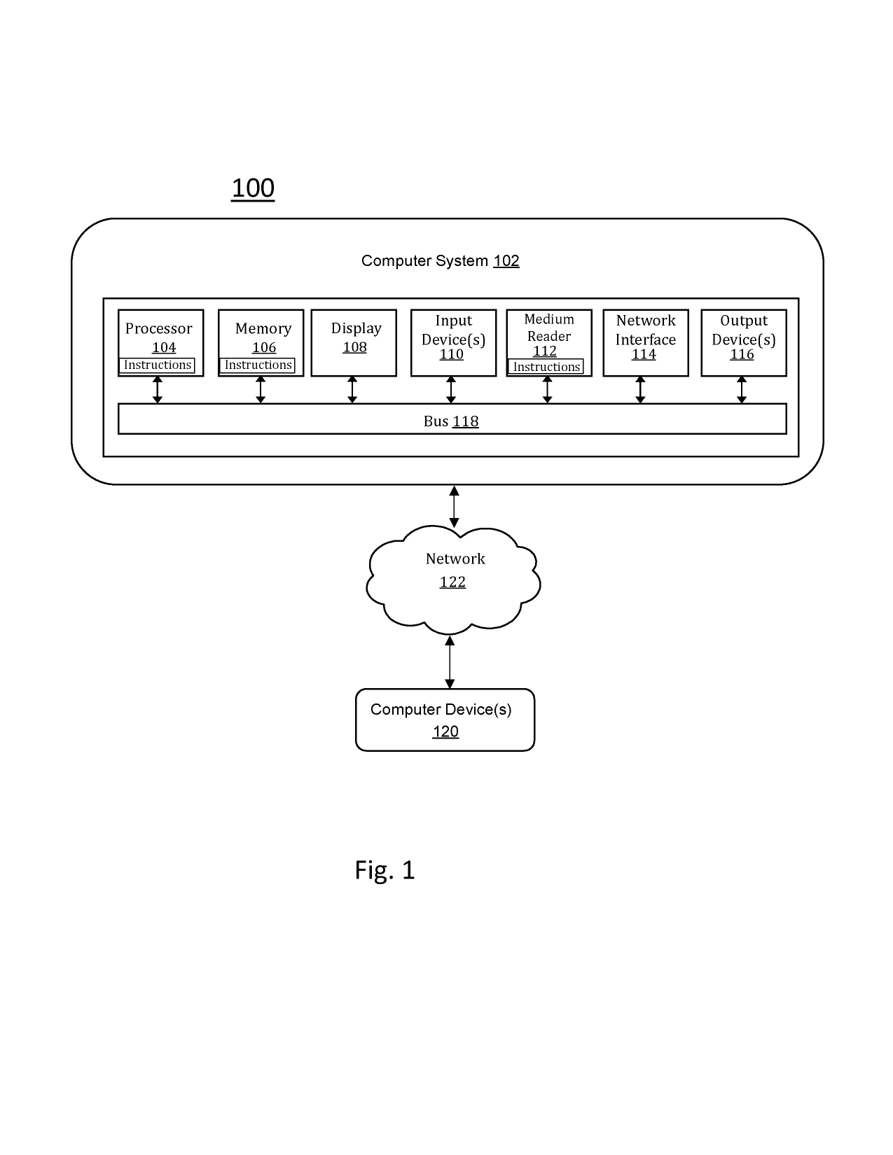

FIG. 1 is an exemplary system 100 for use in implementing a method for using an AI/ML model to provide a low power automated pre-existing solution finder, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain’t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

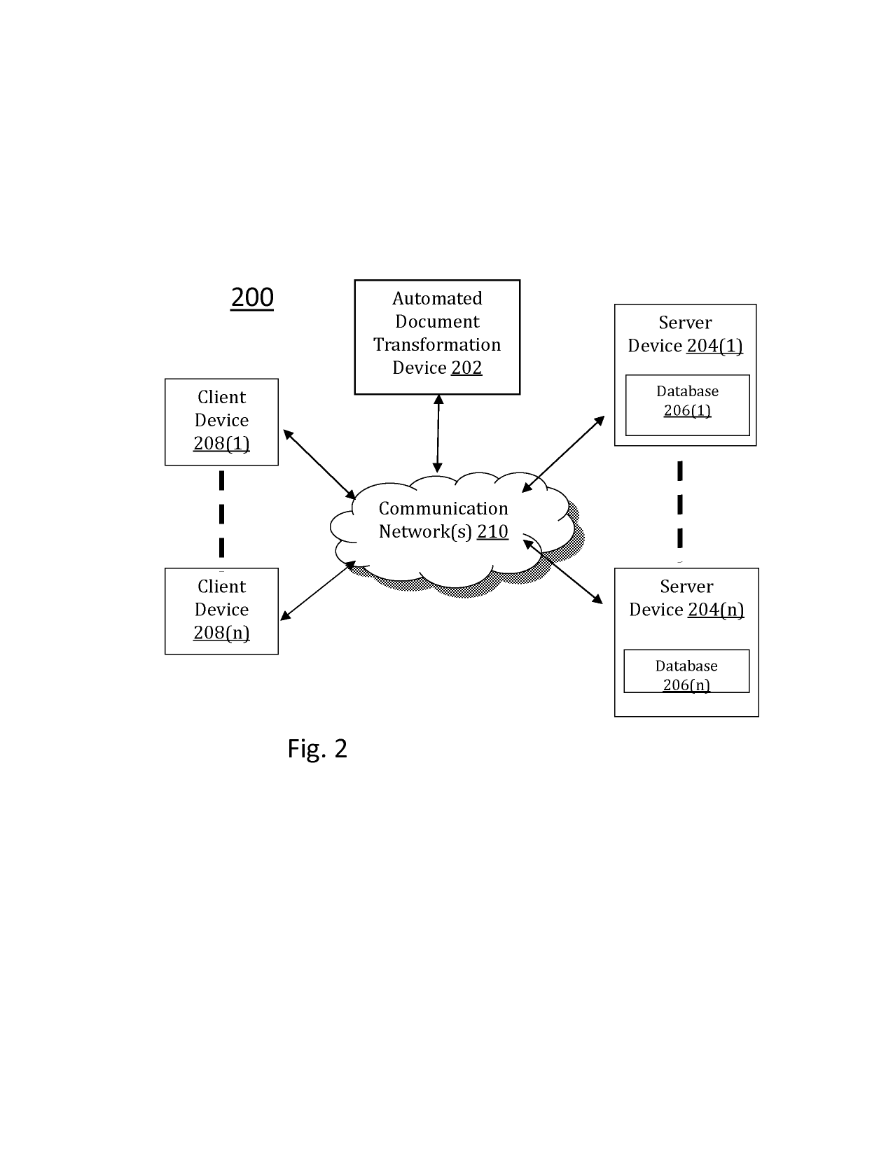

Referring to FIG. 2, a schematic of an exemplary network environment 200 for implementing low power automated pre-existing solution finder device (LPAPSFD) of the instant disclosure is illustrated.

In some embodiments, the above-described problems associated with conventional tools may be overcome by implementing an LPAPSFD 202 as illustrated in FIG. 2 that may be configured for implementing a method for using an AI/ML model to provide a low power automated pre-existing solution finder, but the disclosure is not limited thereto.

The LPAPSFD 202 may have one or more computer system 102s, as described with respect to FIG. 1, which in aggregate provide the necessary functions.

The LPAPSFD 202 may store one or more applications that can include executable instructions that, when executed by the LPAPSFD 202, cause the LPAPSFD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the LPAPSFD 202 itself, may be located in virtual server(s) running in a cloud-based computing environment rather than being tied to one or more specific physical network computing devices. Also, the application(s) may be running in one or more virtual machines (VMs) executing on the LPAPSFD 202. Additionally, in one or more embodiments of this technology, virtual machine(s) running on the LPAPSFD 202 may be managed or supervised by a hypervisor.

In the network environment 200 of FIG. 2, the LPAPSFD 202 is coupled to a plurality of server devices 204(1)-204(n) that hosts a plurality of databases 206(1)-206(n), and also to a plurality of client devices 208(1)-208(n) via communication network(s) 210. A communication interface of the LPAPSFD 202, such as the network interface 114 of the computer system 102 of FIG. 1, operatively couples and communicates between the LPAPSFD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LPAPSFD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The LPAPSFD 202 may be a standalone device or integrated with one or more other devices or apparatuses, such as one or more of the server devices 204(1)-204(n), for example. In one particular example, the LPAPSFD 202 may be hosted by one of the server devices 204(1)-204(n), and other arrangements are also possible. Moreover, one or more of the devices of the LPAPSFD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the LPAPSFD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the LPAPSFD 202 that may efficiently provide a platform for implementing a method for using an AI/ML model to provide a low power automated pre-existing solution finder, but the disclosure is not limited thereto.

The client devices 208(1)-208(n) may run interface applications, such as standard web browsers or standalone client applications, which may provide an interface to communicate with the LPAPSFD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the LPAPSFD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the LPAPSFD 202, the server devices 204(1)-204(n), or the client devices 208(1)-208(n), for example, may be configured to operate as virtual instances on the same physical machine. For example, one or more of the LPAPSFD 202, the server devices 204(1)-204(n), or the client devices 208(1)-208(n) may operate on the same physical device rather than as separate devices communicating through communication network(s) 210. Additionally, there may be more or fewer LPAPSFDs 202, server devices 204(1)-204(n), or client devices 208(1)-208(n) than illustrated in FIG. 2. In some embodiments, the LPAPSFD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

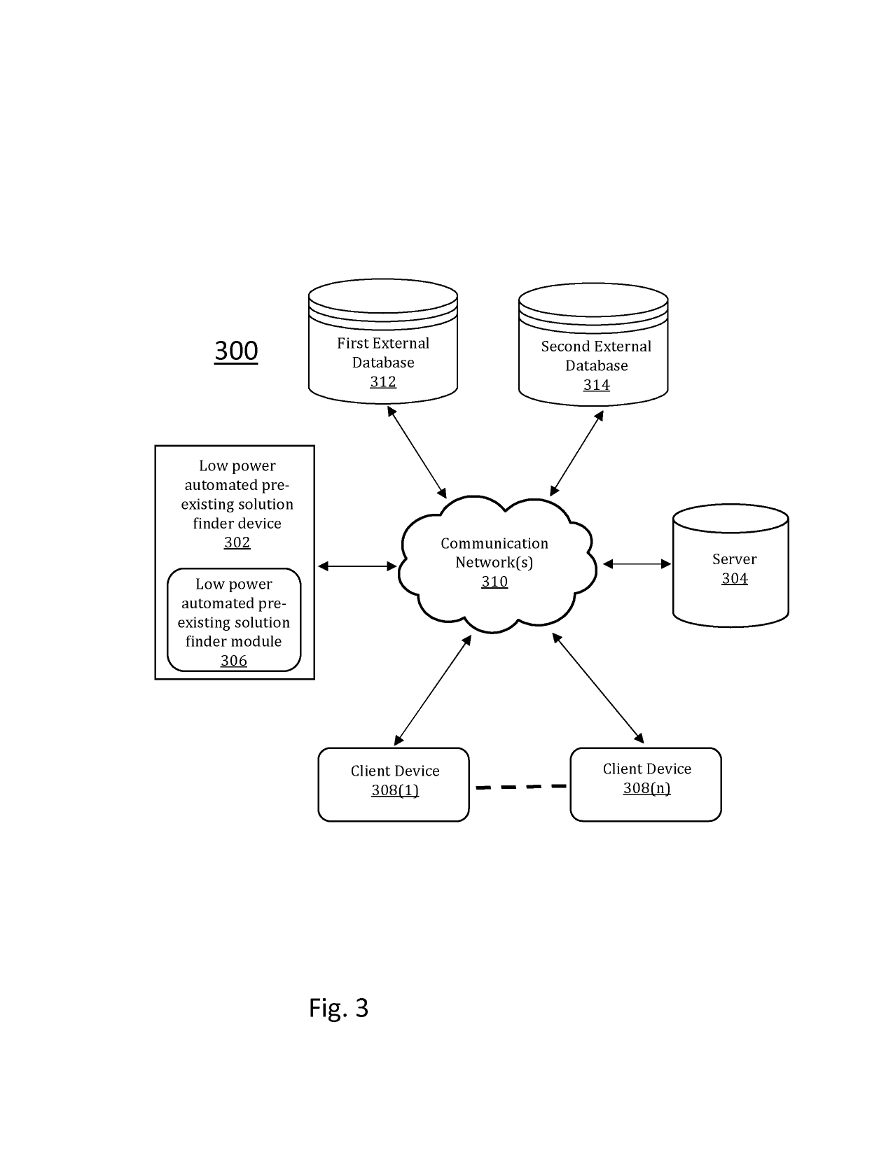

FIG. 3 illustrates a system diagram for implementing an LPAPSFD 302 having a low power automated pre-existing solution finder module (LPAPSFM), in accordance with an embodiment.

As illustrated in FIG. 3, the system 300 may include an LPAPSFD 302 within which an LPAPSFM 306 is embedded, a server 304, a first external database 312, a second external database 314, a plurality of client devices 308(1) … 308(n), and a communication network 310.

In some embodiments, the LPAPSFD 302 including the LPAPSFM 306 may be connected to the server 304, and the database(s) 312 via the communication network 310. The LPAPSFD 302 may also be connected to the plurality of client devices 308(1) … 308(n) via the communication network 310, but the disclosure is not limited thereto.

In an embodiment, the LPAPSFD 302 is described and shown in FIG. 3 as including the LPAPSFM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the LPAPSFM 306 may be configured to receive real-time feed of data from the plurality of client devices 308(1) … 308(n) and secondary sources via the communication network 310.

The plurality of client devices 308(1) … 308(n) are illustrated as being in communication with the LPAPSFD 302. In this regard, the plurality of client devices 308(1) … 308(n) may be “clients” (e.g., customers) of the LPAPSFD 302 and are described herein as such. Nevertheless, it is to be known and understood that the plurality of client devices 308(1) … 308(n) need not necessarily be “clients” of the LPAPSFD 302, or any entity described in association therewith herein. Any additional or alternative relationship may exist between either or both of the plurality of client devices 308(1) … 308(n) and the LPAPSFD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) … 308(n) may communicate with the LPAPSFD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The LPAPSFD 302 may be the same or similar to the LPAPSFD 202 as described with respect to FIG. 2, including any features or combination of features described with respect thereto.

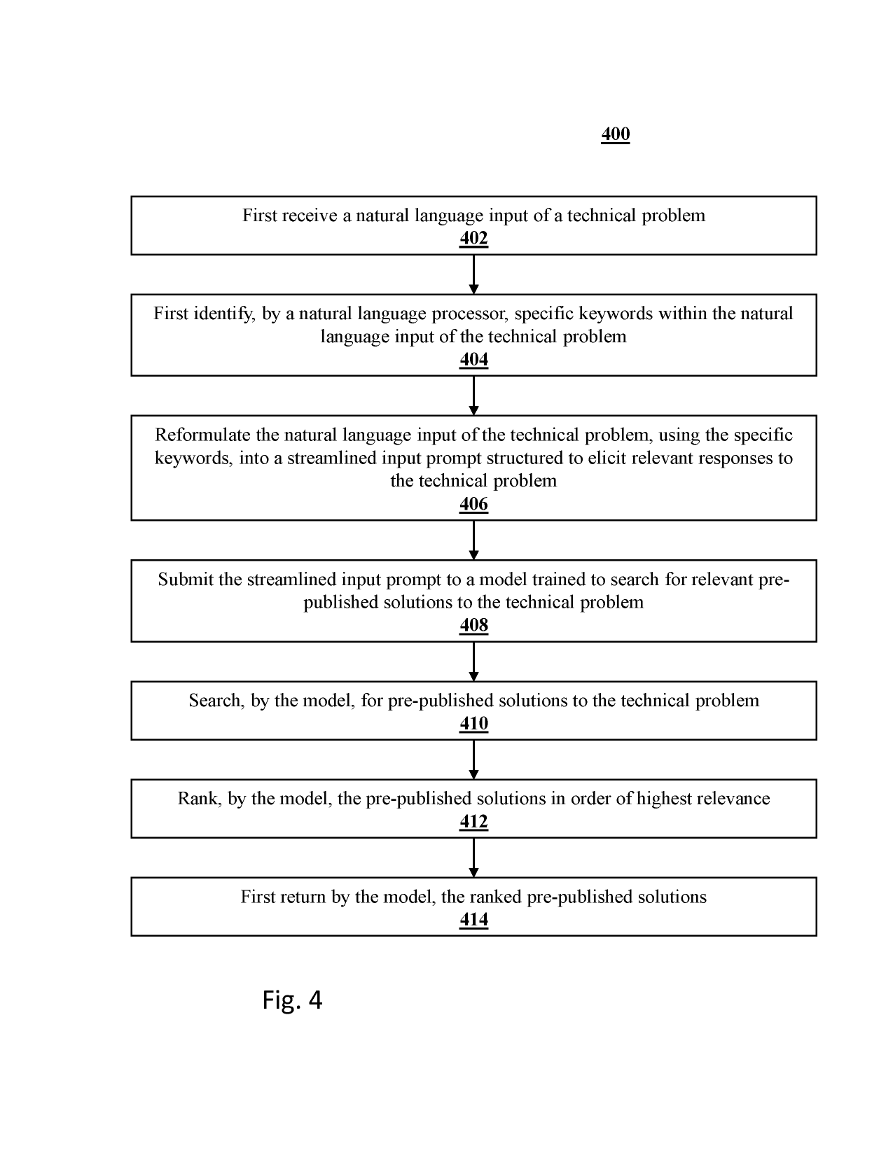

FIG. 4 illustrates an exemplary flow chart of a process 400 implemented by the LPAPSFM 306 of FIG. 3 for enablement of a system and a method to provide a low power automated pre-existing solution finder, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step 402, the process 400 may include first receiving a natural language input of a technical problem.

At step 404, the process 400 may include first identifying, by a natural language processor, specific keywords within the natural language input of the technical problem.

At step 406, the process 500 may include reformulating the natural language input of the technical problem, using the specific keywords, into a streamlined input prompt structured to elicit relevant responses to the technical problem.

At step 408, the process 400 may include submitting the streamlined input prompt to a model trained to search for relevant pre-published solutions to the technical problem.

At step 410, the process 400 may include searching, by the model, for pre-published solutions to the technical problem.

At step 412, the process 400 may include ranking, by the model, the pre-published solutions in order of highest relevance.

At step 414 the process 400 may include first returning, by the model, the ranked pre-published solutions.

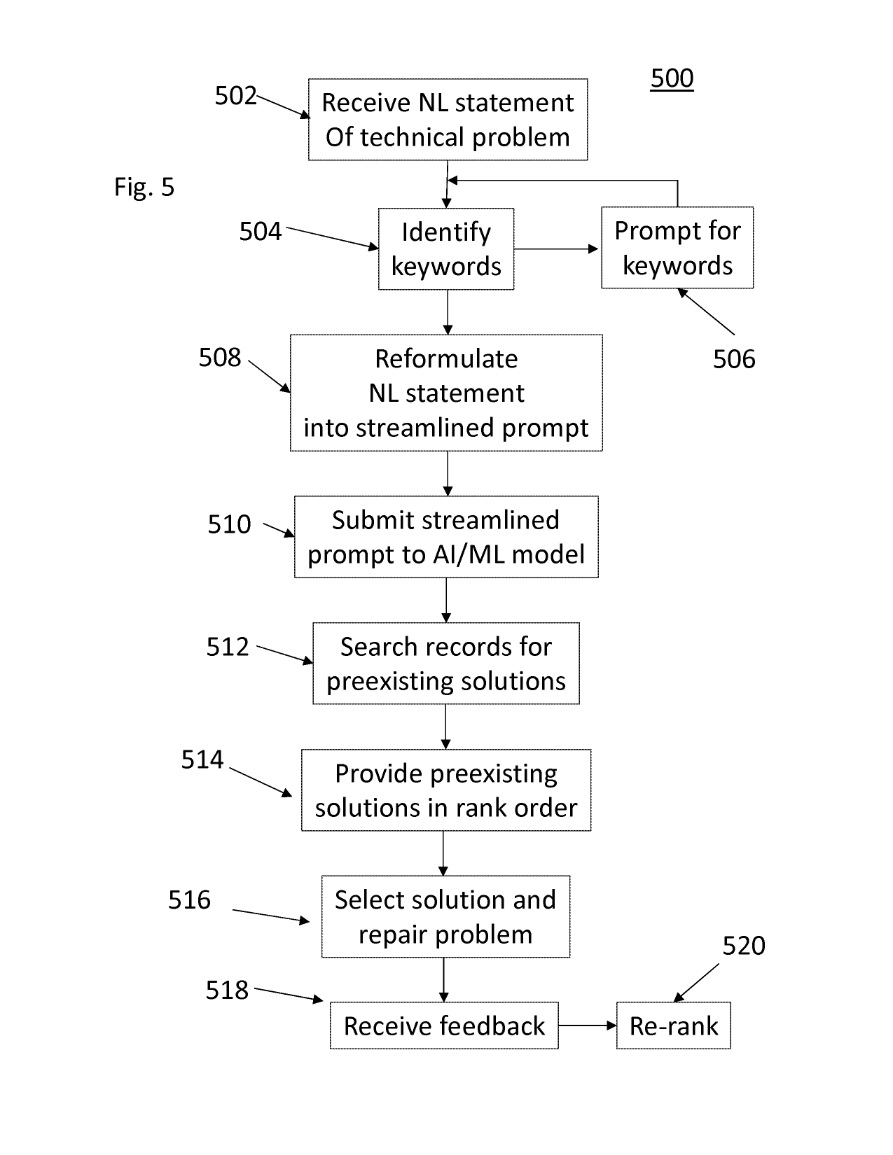

Referring now to FIG. 5, a process 500 is shown for a methodology to search and return pre-published technical solutions for an identified technical problem. At step 502, the methodology receives a natural language statement of the technical problem.

At step 504, a natural language processor looks for specific keywords in the natural language statement, including an underlying infrastructure, underlying services, and an error code, as a prompt that includes such keywords is likely to generate the most relevant responses. If the natural language statement lacks the desired keywords, the natural language processing can prompt the user at step 506 to enter additional information that contains the missing keywords. By way of non-limiting example, the infrastructure could be Private cloud (GAP), Kubernetes/container solution (such as private Kubernetes cloud (GKP)), or Amazon Web Services, and the services could be Message Queue, Kafka, or Active Directory Federation Services.

In this context, infrastructure refers to the underlying hardware and software environment that supports the deployment and operation of applications and services. It includes the foundational components (cloud, containers, AWS, etc.) necessary for an application to run and provides the tools and platforms used to run and scale applications. Services refer to the software or functional components that run on top of the infrastructure to provide specific capabilities to the system or application. Services perform tasks or provide features, such as by way of non-limiting example handling messaging, authentication, or data streaming.

At step 508, the natural language processor reformulates the natural language input using the keywords into a streamlined prompt that is structured to elicit the most relevant responses to the stated technical problem.

At step 510, the streamlined prompt is provided to a trained AI model. At step 512, the trained AI model searches available records for existing pre-published solutions to the technical problem as stated in the streamlined prompt. The search may include searching in a local database, a cache database, an existing document storage, or available software platforms such as Confluence or Service Now.

At step 514, the trained AI model ranks the search results from step 510 and provides them in an order of most relevant existing published solutions. By way of non-limiting example, solutions A-B-C may be ranked first, second, and third respectively. The ranked solutions are stored in memory for later consultation in re-ranking, as discussed below.

A variety of factors may be considered and factor as to what is relevant, including how often a pre-published solution was successfully called and used to repair the technical problem, and/or how pre-published solutions were rated by personnel who applied the solutions. The invention is not limited to the manner in which solutions are ranked.

In some cases, the existing pre-published solutions may have already been ranked for the technical problem, and the preexisting rankings are used to establish the rank order of the search results.

The methodology can also determine whether a preexisting ranking is current based on subsequent events since the preexisting ranking was created, and update the rankings to reflect events since the time of the preexisting ranking. By way of non-limiting example, a new solution may have been published and was not included in the preexisting ranking. In another non-limiting example, an older solution may have become outdated or criticized since the preexisting ranking, and warrant a lower placement. The invention is not limited to the basis on which ranks change.

At step 516, the methodology calls for selecting a technical solution from the search results and repairs the underlying error that is the basis of the technical problem using the selected technical solution.

Most typically the highest-ranking solution would be selected, with lower ranking solutions being selected either if the higher-ranking solutions were ineffective or skipped because they were deemed too complicated relative to other solutions. For example, the highest-ranking solution could be significant code rework while the next ranking solution could be a far simpler hard reboot, and the methodology selects the easier option even though it may be less effective. At step 518, the process 500 submits the ranking for post-processing to consider whether to adjust to re-rank the solutions at 520 in response to user and/or AI/ML model feedback.

User feedback for re-ranking is based on what technical solutions were selected from the rankings and the resulting effectiveness. For example, suppose the rankings returned solutions A-B-C as ranked first, second, and third respectively. The user attempts solution A, which is successful. The resulting feedback confirms that A was appropriate as first ranking.

However, suppose the user instead selected B and found it effective, either because the user found solution A ineffective or too complicated to even try. Then the methodology at step 520 can determine whether this user feedback warrants re-ranking A-B-C (such as B-C-A of B-A-C as first, second and third), or to otherwise leave the ranking undisturbed.

AI/ML model feedback looks at the provided ranked list of technical solutions relative to prior ranked solutions for the same technical problem. Suppose for example that a prior inquiry into the technical problem resulted in an A-B-C ranking, the same ranking as the current inquiry into the technical problem. Since the prior ranking and the current ranking match, that would tend to confirm that the ranked order of A-B-C is correct.

However, suppose a prior ranking for the technical problem was A-K-L and the current ranking is A-B-C. The AI/ML model feedback would be a mismatch, and the methodology at 520 would re-rank to incorporate both in a new order. Solution A was first in both, so it would be first again. Solutions B and C would outrank K and L as they emerged as higher in the more current ranking. Thus, the overall re-rank at 520 would be A-B-C-K-L as first through fifth, respectively.

The invention is not limited to the methodology for deciding how to re-rank the solutions.

Once re-ranked, the solutions remain in memory for consideration by a subsequent process 500 at steps 512 and 514.

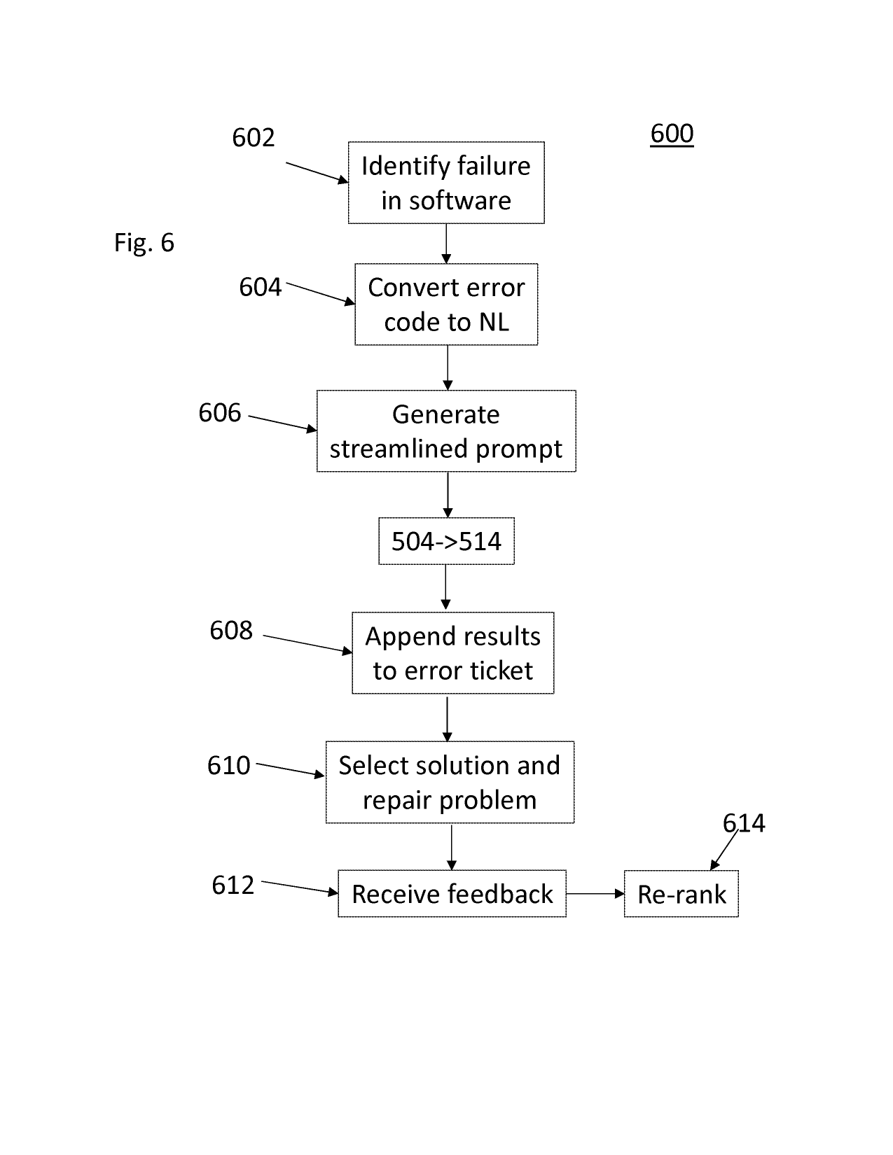

Referring now to FIG. 6, a process 600 is shown for a methodology to search and return pre-published technical solutions for technical problem identified by an AI/ML model.

At step 602, the AI running an application identifies a failure in a software package, such as an application, that generates an error code and an error ticket.

At step 604, a natural language processor converts the error code into a natural language statement of the problem represented by the error code.

At step 606, a trained AI/ML model examines the Application and/or the error code to construct a streamlined prompt that is structured to elicit the most relevant responses to the stated technical problem. Specifically, the trained AI/ML model examines the Application and/or the error code to include keywords in the prompt, where the keywords include at least an underlying infrastructure, underlying services, and an error code.

The output of step 606 is input to the natural language processor of step 504, and undergoes the same processing as described with respect to process 500 via steps 504-514 to locate/generate a ranked order of pre-published technical solutions responsive to the underlying technical problem that generated the error code, although instead of outputting the ranked solutions to a user, the ranked solutions are appended to the records of the error originally detected by the AI in step 602.

At step 608, the results of the search are added to the error ticket for presentation to a supervisory authority.

At step 610 the methodology selects a technical solution from the search results and repairs the underlying error that is the basis of the technical problem using the selected technical solution.

At step 612, the process 600 submits the ranking for post-processing to consider whether to adjust to re-rank the solutions at 614 in response to user and/or AI/ML model feedback. These steps parallel those of steps 518 and 520 above.

The search results from process 500 or 600 are stored in memory for later reference. As noted above, these results may become the ranked pre-existing technical solutions found by a future inquiry by process 500 or 600.

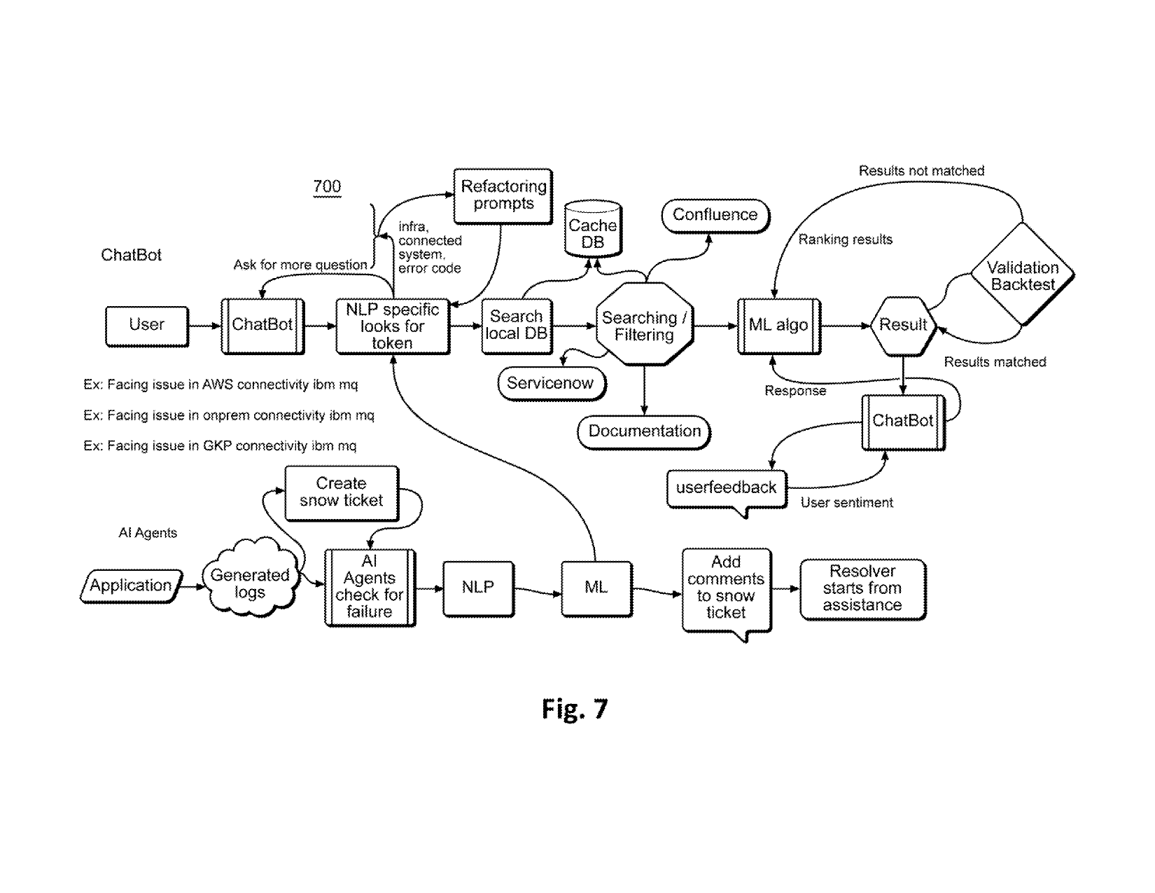

Referring now to FIG. 7, a process 700 for performing an implementation according to an embodiment is shown.

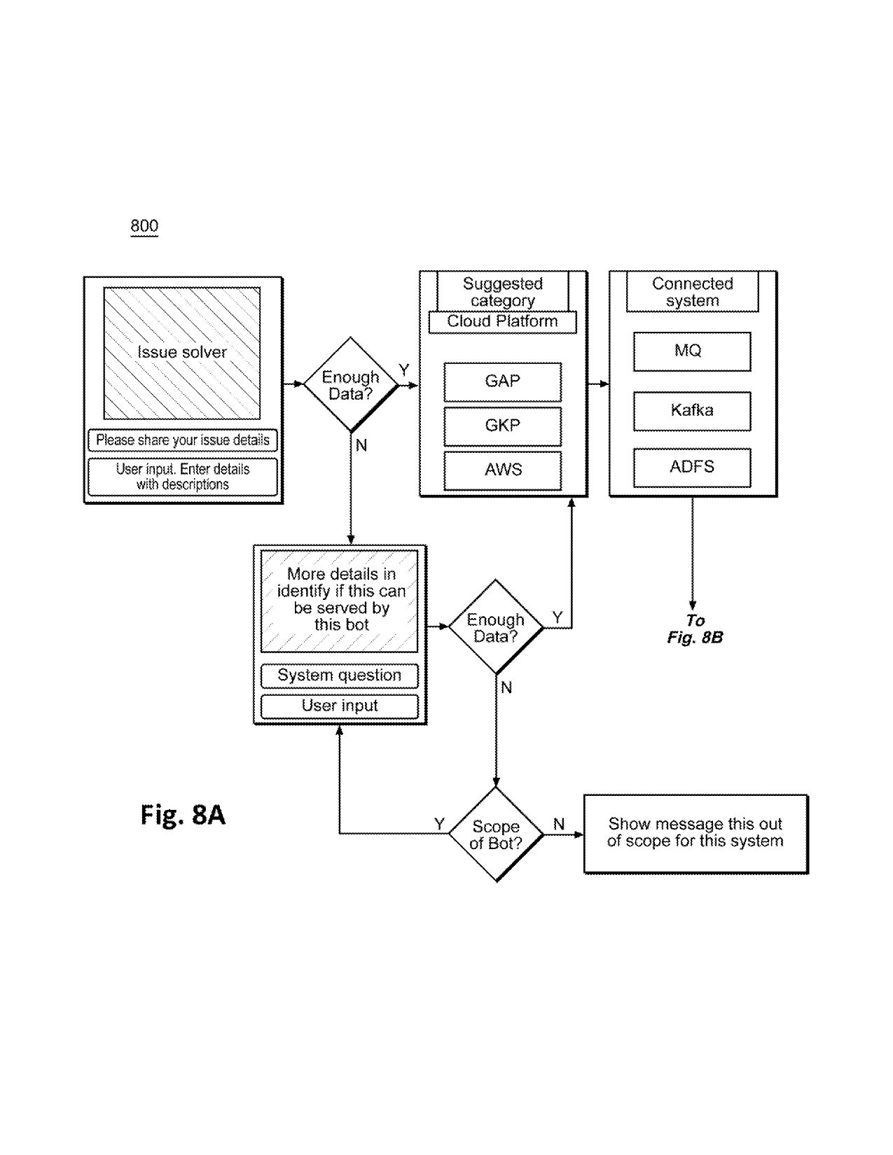

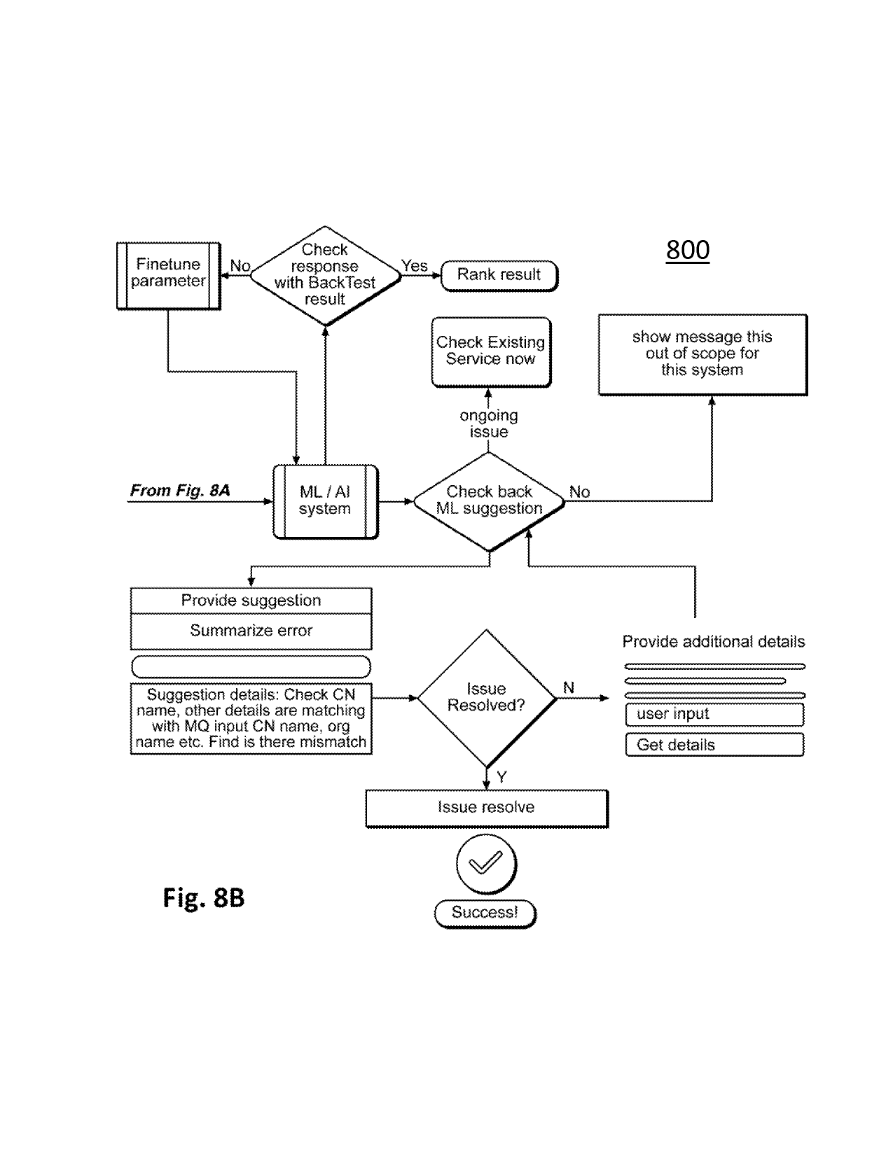

Referring now to FIGS. 8A and 8B, a process 700 for performing an implementation according to an embodiment is shown.

The above methodologies provide a technical solution to the technical problems of traditional methods. The designers will not need to engage in endless brute force searches for solutions. Also, by reformulating the natural language input, using the specific keywords, into a streamlined input prompt structured to elicit relevant responses, the AI prompt is targeted and far more likely to elicit relevant responses from the AI such that resubmissions are less likely. The above methodology thus provides a technical solution to excessive power consumption by reducing the number of AI prompts the user will need to submit to reach an acceptable rank order of pre-existing published solutions. By avoiding extra AI cycles, the methodology avoids the corresponding power expenditure, such that the methodology overall consumes less power. By transforming free-form user input into a structured prompt representation, the system reduces ambiguity and decreases variance in AI-generated outputs.

As a result, the number of iterative prompt submissions required to obtain an acceptable ranked list of pre-existing published solutions is reduced, as the structured prompt representation decreases average resubmission frequency and total token utilization per completed search session. From a computing-resource perspective, each AI prompt submission triggers execution of a high-complexity inference operation across distributed computer infrastructure, consuming processor cycles, memory bandwidth, and electrical power proportional to token count and model depth. By reducing the number of prompt submissions and optimizing token utilization per submission, the disclosed system decreases aggregate inference executions. This directly reduces processor load, GPU utilization time, memory access operations, and network transmission overhead associated with each session.

Accordingly, the disclosed methodology provides a technical improvement to computer-implemented AI query systems by: reducing total inference operations executed by remote AI compute clusters; reducing token processing volume per user task; reducing GPU/CPU processing cycles and associated electrical power consumption; reducing network bandwidth utilization between client and AI service endpoints; and improving response determinism and ranking convergence rate within AI-assisted prior-art search workflows.

Also, by reformulating the natural language input, using the specific keywords, into a streamlined input prompt structured to elicit relevant responses, a simpler AI/ML model can be used as it has less parameters to consider, which independently results in savings in electrical power. The instant AI model may be simpler than a general purpose AI model in that it may be specifically designed as a special purpose model programmed and trained to operate off the specific keywords as specific input parameters rather than a general purpose AI model that works off any parameters, and thus consumes less electrical power than a general purpose AI model Thus a technical improvement in power savings is realized via both a less power hungry AI/ML model and a lower number of submissions, thus reducing the per search power consumption and the number of searches that draw power.

Because the input is normalized into a predefined parameter space, the downstream model is not required to support open-domain inference across arbitrarily structured inputs. Instead, the model operates on a bounded feature vector derived from extracted keywords, domain classifications, and structured ranking constraints. The simplified and special purpose model architecture by its nature includes fewer transformer layers, reduced attention head counts, smaller embedding dimensionality, or a compressed parameter set relative to a general-purpose large language model. Because the model receives semantically filtered and structured inputs rather than free-form text, the inference search space is reduced, permitting lower computational depth while maintaining task-specific accuracy.

Unlike a general-purpose AI model configured to process arbitrary natural language across broad domains, the disclosed special-purpose model is trained and programmed to operate on defined keyword fields and structured prompt parameters as explicit input variables. This constrained input design reduces token entropy, minimizes internal attention operations, and decreases the number of multiply-accumulate operations executed during inference. As a result, GPU/CPU utilization time, memory bandwidth usage, and cache access frequency are reduced relative to execution of a larger, general-purpose model.

In some embodiments as disclosed above in FIGS. 1-8B, technical improvements effected by the instant disclosure may include a platform for implementing a low power automated pre-existing solution finder, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method, comprising:
first receiving a natural language input of a technical problem;
first identifying, by a natural language processor, specific keywords within the natural language input of the technical problem;
reformulating the natural language input of the technical problem, using the specific keywords, into a streamlined input prompt structured to elicit relevant responses to the technical problem;
submitting the streamlined input prompt to a model trained to search for relevant pre-published solutions to the technical problem;
searching, by the model, for pre-published solutions to the technical problem;
ranking, by the model, the pre-published solutions in order of highest relevance; and
first returning by the model, the ranked pre-published solutions.

2. The method of claim 1, wherein the specific keywords include an underlying infrastructure, underlying services, and an error code for the technical problem.

3. The method of claim 1, further comprising:
prompting, in response to the identifying failing to identify all needed keywords, entry of additional information describing the technical problem;
second receiving the additional information; and
second returning to the first identifying.

4. The method of claim 1, where the ranking comprises second identifying a pre-existing rank order of the pre-published solutions.

5. The method of claim 4, further comprising:
determining whether the pre-existing rank order is current.

6. The method of claim 5, further comprising:
updating, in response to a negative result of the determining, rank order of the pre-existing rank order.

7. The method of claim 1, further comprising:
selecting a pre-published solution from the ranked pre-published solutions; and
repair the technical problem per the selected pre-published technical solution.

8. A system, comprising:
a processor;
a non-transitory computer readable memory storing instructions programmed to cooperate with the processor to perform operations comprising:
first receiving a natural language input of a technical problem;
first identifying, by a natural language processor, specific keywords within the natural language input of the technical problem;
reformulating the natural language input of the technical problem, using the specific keywords, into a streamlined input prompt structured to elicit relevant responses to the technical problem;
submitting the streamlined input prompt to a model trained to search for relevant pre-published solutions to the technical problem;
searching, by the model, for pre-published solutions to the technical problem;
ranking, by the model, the pre-published solutions in order of highest relevance; and
first returning by the model, the ranked pre-published solutions.

9. The system of claim 8, wherein the specific keywords include an underlying infrastructure, underlying services, and an error code for the technical problem.

10. The system of claim 8, the operations further comprising:
prompting, in response to the identifying failing to identify all needed keywords, entry of additional information describing the technical problem;
second receiving the additional information; and
second returning to the first identifying.

11. The system of claim 8, where the ranking comprises second identifying a pre-existing rank order of the pre-published solutions.

12. The system of claim 11, the operations further comprising:
determining whether the pre-existing rank order is current.

13. The system of claim 12, the operations further comprising:
updating, in response to a negative result of the determining, rank order of the pre-existing rank order.

14. The system of claim 8, the operations further comprising:
selecting a pre-published solution from the ranked pre-published solutions; and
repair the technical problem per the selected pre-published technical solution.

15. A non-transitory computer readable media storing instructions programmed to cooperate with a processor to cause the processor to perform operations comprising:
first receiving a natural language input of a technical problem;
first identifying, by a natural language processor, specific keywords within the natural language input of the technical problem;
reformulating the natural language input of the technical problem, using the specific keywords, into a streamlined input prompt structured to elicit relevant responses to the technical problem;
submitting the streamlined input prompt to a model trained to search for relevant pre-published solutions to the technical problem;
searching, by the model, for pre-published solutions to the technical problem;
ranking, by the model, the pre-published solutions in order of highest relevance; and first returning by the model, the ranked pre-published solutions.

16. The non-transitory computer readable media of claim 15, wherein the specific keywords include an underlying infrastructure, underlying services, and an error code for the technical problem.

17. The non-transitory computer readable media of claim 15, the operations further comprising:
prompting, in response to the identifying failing to identify all needed keywords, entry of additional information describing the technical problem;
second receiving the additional information; and
second returning to the first identifying.

18. The non-transitory computer readable media of claim 15, where the ranking comprises second identifying a pre-existing rank order of the pre-published solutions.

19. The non-transitory computer readable media of claim 18, the operations further comprising:
determining whether the pre-existing rank order is current.

20. The non-transitory computer readable media of claim 19, the operations further comprising:
updating, in response to a negative result of the determining, rank order of the pre-existing rank order.
